(19) United States
(12) Patent Application Publication
(10) Pub. No.: US 2026/0276465 A1
(43) Pub. Date: Sep. 17, 2026

(54) BIONIC MECHANICAL SENSOR

(71) Applicant: Advanced Semiconductor Engineering, Inc., Kaohsiung (TW)

(72) Inventor: Chun-Kai CHANG, Kaohsiung (TW)

(73) Assignee: Advanced Semiconductor Engineering, Inc., Kaohsiung (TW)

(21) Appl. No.: 19/080,762

(22) Filed: Mar. 14, 2025

(51) Int. Cl. G01L 5/22; B25J 13/08; G01L 1/14; G01L 1/16

(52) U.S. Cl. CPC G01L 5/228; B25J 13/082; B25J 13/084; G01L 1/14; G01L 1/16

(57) ABSTRACT

The present disclosure provides a bionic mechanical sensor. The bionic mechanical sensor includes a first rotatable region, a second rotatable region, an encapsulant, a plurality of sensors, and a conductive element. The encapsulant covers the first rotatable region and the second rotatable region and is exposed to an external environment. The plurality of sensors are within the first rotatable region and the second rotatable region. The conductive element is electrically connected to the plurality of sensors and embedded within the encapsulant.

### BACKGROUND

### 1. Technical Field

The present disclosure relates to a bionic mechanical sensor.

### 2. Description of the Related Art

Robotics is experiencing rapid development, with humanoid robots being particularly popular. The present robots primarily rely on computer control to perform specific actions. However, with technology evolving, robots need to possess a high level of perception and cognitive abilities to operate and interact within complex environments. For example, a robot is required to be able to sense how much force to apply when picking up an object (such as an egg) to avoid using too much force, which could damage the object, or too little force, which could result in failing to pick it up successfully. Therefore, an improved electronic device for robotic arm with sensors is called for.

### SUMMARY

In some arrangements, a bionic mechanical sensor includes a first rotatable region, a second rotatable region, an encapsulant, a plurality of sensors, and a conductive element. The encapsulant covers the first rotatable region and the second rotatable region and is exposed to an external environment. The plurality of sensors are within the first rotatable region and the second rotatable region. The conductive element is electrically connected to the plurality of sensors and embedded within the encapsulant.

In some arrangements, a bionic mechanical sensor includes a first rotatable region, a second rotatable region, an encapsulant, a conductive element, and a driver. The encapsulant covers the first rotatable region and the second rotatable region and is configured to contact an object. The conductive element is embedded within the encapsulant and connects the first rotatable region and the second rotatable region. The driver is disposed between the first rotatable region and the second rotatable region and is configured to control a relative motion between the first rotatable region and the second rotatable region.

In some arrangements, a bionic mechanical sensor includes an encapsulant, a sensing region, and mechanical module. The encapsulant has an outer surface configured to be in contact with or approaching an object. The sensing region is configured to generate a signal in response to the object in contact with or approaching the encapsulant. The mechanical module is configured to deform the encapsulant in response to the signal. The sensing region is closer to the outer surface of the encapsulant than the mechanical module is.

### BRIEF DESCRIPTION OF THE DRAWINGS

Aspects of some arrangements of the present disclosure are best understood from the following detailed description when read with the accompanying figures. It should be noted that various structures may not be drawn to scale, and dimensions of the various structures may be arbitrarily increased or reduced for clarity of discussion.

FIG. 1A illustrates a perspective view of a bionic mechanical sensor, in accordance with some arrangements of the present disclosure.

FIG. 1B illustrates a cross-sectional view of a bionic finger, in accordance with some arrangements of the present disclosure.

FIG. 2A illustrates an enlarged view of a bionic finger, in accordance with some arrangements of the present disclosure.

FIG. 2B illustrates a layout of sensor on the bionic finger, in accordance with some arrangements of the present disclosure.

FIG. 3 illustrates a cross-sectional view of a bionic finger, in accordance with some arrangements of the present disclosure.

FIG. 4 illustrates a cross-sectional view of a bionic finger, in accordance with some arrangements of the present disclosure.

FIG. 5 is a flowchart illustrating the method of an operation of a bionic mechanical sensor, in accordance with some arrangements of the present disclosure.

FIG. 6A and FIG. 6B illustrate stages of an example of a method of an operation of a bionic mechanical sensor according to some embodiments of the present disclosure.

### DETAILED DESCRIPTION

The following disclosure provides many different arrangements, or examples, for implementing different features of the provided subject matter. Specific examples of components and arrangements are described below to explain certain aspects of the present disclosure. These are, of course, merely examples and are not intended to be limiting. For example, the formation of a first feature over or on a second feature in the description that follows may include arrangements in which the first and second features are formed or disposed in direct contact, and may also include arrangements in which additional features may be formed or disposed between the first and second features, such that the first and second features may not be in direct contact. In addition, the present disclosure may repeat reference numerals and/or letters in the various examples. This repetition is for the purpose of simplicity and clarity and does not in itself dictate a relationship between the various arrangements and/or configurations discussed.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of arrangements of this disclosure are not deviated from by such arrangement.

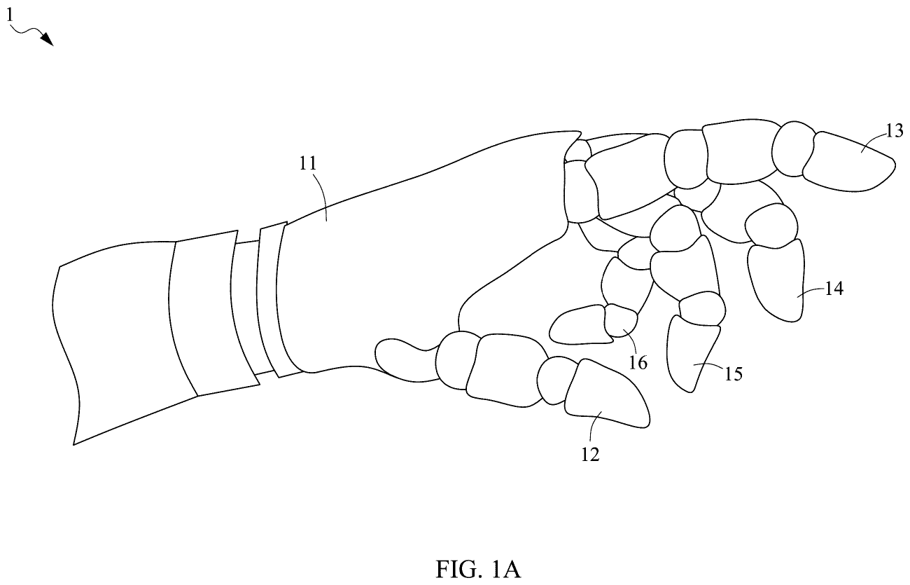

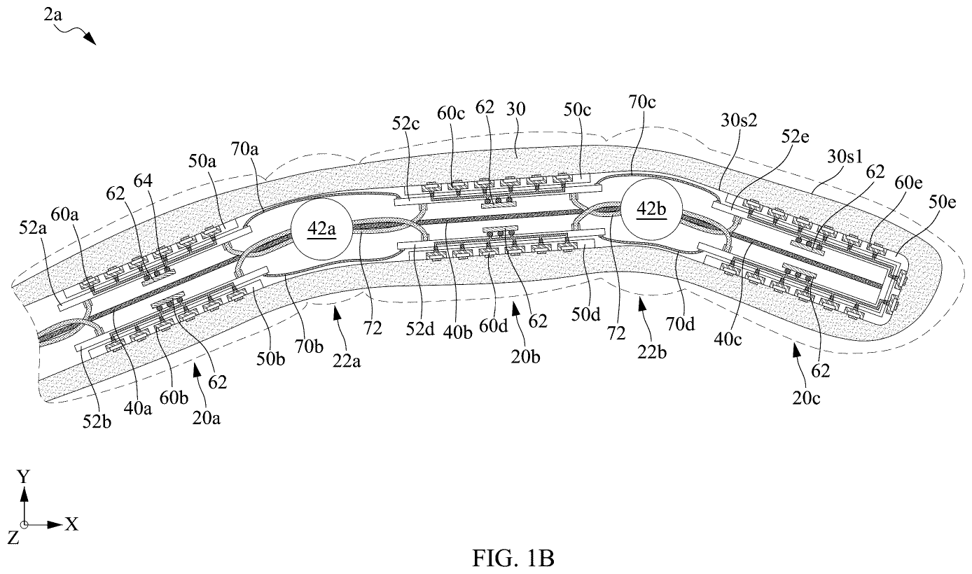

FIG. 1A illustrates a perspective view of a bionic mechanical sensor 1, in accordance with some arrangements of the present disclosure. In some arrangements, the bionic mechanical sensor 1 may be included in a robot, particularly a humanoid robot. For clarity, FIG. 1A merely shows a part of the bionic mechanical sensor 1, in particular the palm, thumb, and fingers. In some arrangements, the bionic mechanical sensor 1 may be configured to contact, hold, or grab an object (or external object). In some arrangements, when the bionic mechanical sensor 1 contacts, holds, or grabs an object, the bionic mechanical sensor 1 may be configured to generate and/or transmit a sensing signal in accordance with the stress imposed on the thumb and/or fingers. In some arrangements, the bionic mechanical sensor 1 may be configured to generate and/or transmit a control signal, in response to the sensing signal, to control, adjust, and/or modify the relative positions (or relative motions) among the thumb, fingers and/or objects, thereby regulating the stress applied to the bionic mechanical sensor 1. Consequently, this functionality may help to minimize degradation or damage to the bionic mechanical sensor 1.

In some arrangements, the bionic mechanical sensor 1 may include palm unit 11, mechanical units 12, 13, 14, 15, and 16. Each of the mechanical units 12, 13, 14, 15, and 16 may be mechanically coupled to the palm unit 11 independently. In some arrangements, each of the mechanical units 12, 13, 14, 15, and 16 may be rotated along the X-direction, Y-direction, and/or Z-direction independently. In some arrangements, the mechanical unit 12 may be configured to mimic an abduction movement of a human thumb. In some arrangements, the mechanical unit 13 may be configured to mimic an abduction movement of a human index finger. In some arrangements, the mechanical unit 14 may be configured to mimic an abduction movement of a human middle finger. In some arrangements, the mechanical unit 15 may be configured to mimic an abduction movement of a human ring finger. In some arrangements, the mechanical unit 16 may be configured to mimic an abduction movement of a human little finger. In some arrangements, the bionic mechanical sensor 1 may include curl joints (not denoted) coupled between the palm unit 11 and mechanical unit 12 (or mechanical unit 13, 14, 15, or 16). The curl joints may pivotally couple to the mechanical units 12, 13, 14, 15, and 16. In some arrangements, the bionic mechanical sensor 1 may include processors and controllers that are electrically coupled to the palm unit 11 and mechanical units 12, 13, 14, 15, and 16, thereby controlling, adjusting, and/or modifying the relative positions (or relative motions) among the palm unit 11 and mechanical units 12, 13, 14, 15, and 16.

FIG. 1B illustrates a cross-sectional view of a bionic finger 2, in accordance with some arrangements of the present disclosure. In some arrangements, each of the mechanical units 13, 14, 15, and 16 may have a structure and function the same as or similar to those of the bionic finger 2.

In some arrangements, the bionic finger 2 may include phalange regions 20a, 20b, and 20c (or portions or sensing regions or rotatable regions). Each of the phalange regions 20a, 20b, and 20c may be configured to mimic an abduction movement of a human phalange. In some arrangements, the bionic finger 2 may include joint regions 22a and 22b. The joint region 22a (or knuckle region) may be mechanically coupled and disposed between the phalange regions 20a and 20b. The joint region 22b may be mechanically coupled and disposed between the phalange regions 20b and 20c. In some arrangements, the joint region 22a may be configured to control, adjust, and/or modify the relative positions (or relative motions) of the phalange regions 20a and 20b. In some arrangements, the joint region 22b may be configured to control, adjust, and/or modify the relative positions (or relative motions) of the phalange regions 20b and 20c. In some arrangements, each of the phalange regions 20a, 20b, and 20c may be configured to rotate along the X-direction, Y-direction, Z-direction, and a combination thereof, dependently or independently of the joint regions 22a and/or 22b, which serve as the rotational axis. In some arrangements, each of the phalange regions 20a, 20b, and 20c may be configured to contact, hold, or grasp an object. In some arrangements, each of the phalange regions 20a, 20b, and 20c may be configured to generate or transmit a sensing signal(s) in response to the stress generated by an object. In some arrangements, each of the phalange regions 20a, 20b, and 20c may be configured to move and/or rotate in response to the sensing signal(s), thereby modifying the relative positions (or relative motions) between an object and the phalange region 20a, 20b, and/or 20c.

In some arrangements, the bionic finger 2 may include an encapsulant 30. The encapsulant 30 may mimic the function of a human skin. The encapsulant 30 may be exposed to an external environment. In some arrangements, the encapsulant 30 may encapsulate or be disposed within the phalange regions 20a, 20b, and 20c. In some arrangements, the encapsulant 30 may encapsulate, cover, and enclose the joint regions 22a and 22b or be disposed within the joint regions 22a and 22b. In some arrangements, the encapsulant 30 may include a flexible or extendable material. In some arrangements, the encapsulant 30 may include a thermal thermoplastic material, a thermal set material, or other suitable materials. In some arrangements, the encapsulant 30 may include a liquid silicone rubber (LSR) or other suitable materials. In some arrangements, the encapsulant 30 may undergo deformation or extension in response to the changes in the relative positions (or relative motions) of the phalange region 20a, 20b, and/or 20c. The encapsulant 30 may have a surface 30s1 (or outer surface) and a surface 30s2 (or inner surface). The surface 30s1 may be configured to contact an object. The surface 30s2 may be configured to define a space accommodating the sensors, frames, derivers, and/or other suitable elements.

In some arrangements, the bionic finger 2 may include frames 40a, 40b, and 40c. The frame 40a may be disposed within the phalange region 20a and mechanically coupled to the joint region 22a. The frame 40b may be disposed within the phalange region 20b and mechanically coupled to the joint regions 22a and 22b. The frame 40c may be disposed within the phalange region 20c and mechanically coupled to the joint region 22b. In some arrangements, each of the frames 40a, 40b, and 40c may be configured to be rotated along the X-direction, Y-direction, Z-direction, and a combination thereof, dependently or independently of the joint regions 22a and/or 22b, which serve as the rotational axis. The relative positions (or relative motions) among the phalange regions 20a, 20b, and 20c can be changed by the rotation of the frames 40a, 40b, and 40c. Each of the frames 40a, 40b, and 40c may include copper, aluminum, tin, gold, silver, nickel, or stainless steel, or a mixture, an alloy, or other combination thereof.

In some arrangements, the bionic finger 2 may include drivers 42a and 42b. The driver 42a may be disposed within the joint region 22a. The driver 42b may be disposed within the joint region 22b. The driver 42a may be mechanically coupled and disposed between the frames 40a and 40b. The driver 42b may be mechanically coupled and disposed between the frames 40b and 40c. In some arrangements, each of the drivers 42a and 42b may function as a rotational axis around which the frames 40a, 40, and 40c can rotate. In some arrangements, the driver 42a may be configured to control, adjust, and/or modify the relative positions (or relative motions) of the frames 40a and 40b. In some arrangements, the driver 42b may be configured to control, adjust, and/or modify the relative positions (or relative motions) of the frames 40b and 40c. In some arrangements, the driver 42a may be configured to rotate and/or move the frame 40a and/or 40b. In some arrangements, the driver 42b may be configured to rotate and/or move the frame 40b and/or 40c. In some arrangements, each of the drivers 42a and 42b may be configured to rotate and/or move the frames 40a, 40b, and/or 40c in response to a control signal. In some arrangements, the drivers 42a and 42b may include motors or other suitable drivers.

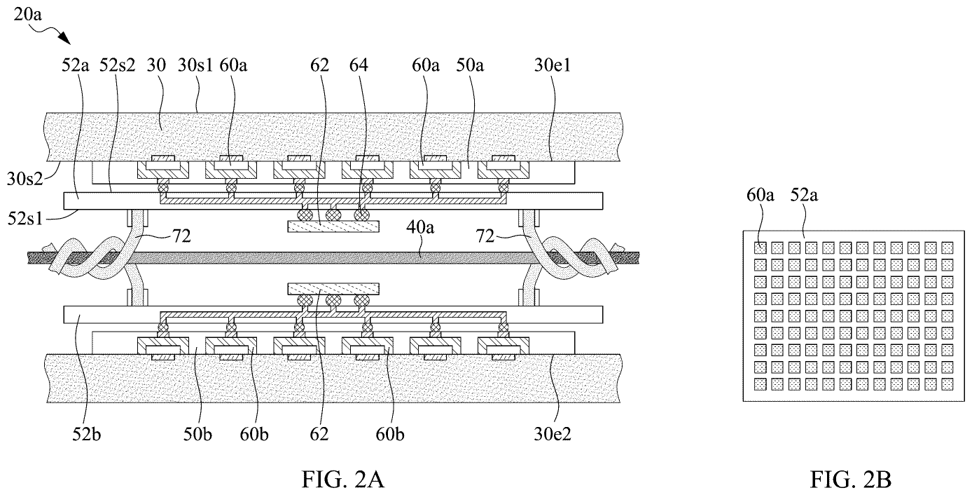

In some arrangements, the bionic finger 2 may include carriers 50a, 50b, 50c, 50d, and 50e In some arrangements, the carriers 50a, 50b, 50c, 50d, and 50e may be disposed on or attached to the surface 30s2 of the encapsulant 30. The carriers 50a and 50b may be disposed within the phalange region 20a. The carriers 50c and 50d may be disposed within the phalange region 20b. The carrier 50c may be disposed within the phalange region 20c. The carriers 50a, 50b, 50c, 50d, and 50e may be configured to accommodate sensors (e.g., sensors 60a, 60b, 60c, 60d, and 60e) and electrical interconnections (e.g., traces, solder materials). The carriers 50a, 50b, 50c, 50d, and 50e may include copper, aluminum, tin, gold, silver, nickel, or stainless steel, or a mixture, an alloy, or other combination thereof. The carriers 50a, 50b, 50c, 50d, and 50e may include a polymer or other suitable materials. The carriers 50a and 50b may be disposed on two opposite sides of the phalange region 20a in a cross-sectional view. For example, as shown in FIG. 2A, the encapsulant 30 may have a side 30e1 and a side 30e2 facing the side 30e1. The carrier 50a may abut or be disposed on the side 30e1. The carrier 50b may abut or be disposed on the side 30e2. As shown in FIG. 1B, the carrier 50e may have a substantially U-shaped profile. In other arrangements, the carrier 50e may have separated segments on different regions of the phalange region 20c.

In some arrangements, the bionic finger 2 may include circuit structures 52a, 52b, 52c, 52d and 52e. In some arrangements, the circuit structures 52a, 52b, 52c, 52d, and 52e may be disposed on the carriers 50a, 50b, 50c, 50d, and 50e, respectively. The circuit structures 52a, 52b, 52c, 52d, and 52e may be spaced apart from the encapsulant by the carriers 50a, 50b, 50c, 50d, and 50e, respectively. The circuit structures 52a and 52b may be disposed within the phalange region 20a. The circuit structures 52c and 52d may be disposed within the phalange region 20b. The circuit structure 52c may be disposed within the phalange region 20c. The circuit structure 52e may have a substantially U-shaped profile. In other arrangements, the circuit structure 52e may have separated segments on different regions of the phalange region 20c. In some arrangements, the circuit structures 52a, 52b, 52c, 52d, and 52e may be configured to transmit sensing signals and/or control signals among the phalange regions 20a, 20b, and 20c as well as the joint regions 22a and 22b. In some arrangements, each of the circuit structures 52a, 52b, 52c, 52d, and 52e may include a printed circuit board (PCB), a flexible printed circuit board (FPCB), or other suitable components. Each of the circuit structures 52a, 52b, 52c, 52d, and 52e may include multiple metal layers separated from one another by layers of dielectric material and interconnected by electrically conductive vias.

In some arrangements, the bionic finger 2 may include sensors 60a, 60b, 60c, 60d, and 60e The sensors 60a may be disposed within the phalange region 20a and electrically connected to the circuit structure 52a. The sensors 60a may be embedded within the carrier 50a. The sensors 60b may be disposed within the phalange region 20a and electrically connected to the circuit structure 52b. The sensors 60b may be embedded within the carrier 50b. The sensors 60c may be disposed within the phalange region 20b and electrically connected to the circuit structure 52c. The sensors 60c may be embedded within the carrier 50c. The sensors 60d may be disposed within the phalange region 20b and electrically connected to the circuit structure 52d. The sensors 60d may be embedded within the carrier 50d. The sensors 60e may be disposed within the phalange region 20c and electrically connected to the circuit structure 52e. The sensors 60e may be embedded within the carrier 50e. In some arrangements, the sensors 60a, 60b, 60c, 60d, and 60e may be configured to generate and/or transmit sensing signals in response to the stress generated by an object. In some arrangements, each of the sensors 60a, 60b, 60c, 60d, and 60e may include capacitive sensors, piezoelectric sensors, or other suitable sensors. In some arrangements, the sensors 60a and 60b may be disposed on two opposite sides of the phalange region 20a in a cross-sectional view. For example, as shown in FIG. 2A, the sensors 60a may abut or be disposed on or abut the side 30e1. The sensors 60b may abut or be disposed on or abut the side 30e2. As shown in FIG. 2B, the sensors 60a (or sensors 60b to sensors 60e) may have an array arrangement, such as N×N array.

In some arrangements, the bionic finger 2 may include electronic components 62. Each of the electronic components 62 may include a semiconductor die or a chip, such as a logic die (e.g., application processor (AP), system-on-a-chip (SoC), central processing unit (CPU), graphics processing unit (GPU), microcontroller, etc.), a memory die (e.g., dynamic random access memory (DRAM) die, static random access memory (SRAM) die, etc.), a power management die (e.g., power management integrated circuit (PMIC) die), a radio frequency (RF) die, a sensor die, a micro-electro-mechanical-system (MEMS) die, a signal processing die (e.g., digital signal processing (DSP) die), a front-end die (e.g., analog front-end (AFE) dies) or other active components.

In some arrangements, the electronic components 62 may function as controllers. In some arrangements, the electronic components 62 may be configured to process sensing signals from the sensors 60a, 60b, 60c, 60d, and 60e. In some arrangements, the electronic components 62 may be configured to transmit processed sensing signals to processors (not shown). In some arrangements, in response to signals from the processors, the electronic components 62 may be configured to generate a control signal to the driver 42a and/or 42b, thereby rotating the frame 40a, 40b, and/or 40c. As shown in FIG. 2A, the electronic components 62 and the sensors 60a may be disposed on two opposite sides of the circuit structure 52a. For example, the circuit structure 52a may have a surface 52s1 and a surface 52s2 opposite to the surface 52s1. The surface 52s2 may face the encapsulant 30. The electronic components 62 may be disposed on the surface 52s1 of the circuit structure 52a. The sensors 60a may be disposed on the surface 52s2 of the circuit structure 52a.

In some arrangements, the bionic finger 2 may include electrical connections 64. As shown in FIG. 2A, the electrical connections 64 may be configured to electrically couple the electronic components 62 and the circuit structure 52a. The electrical connections 64 may include a reflowable material or a solder material. The electrical connections 64 may be or include electrical contacts, such as solder balls, conductive bumps, or the like. The electrical connections 64 may include alloys of gold and tin solder or alloys of silver and tin solder, or other suitable materials. In other arrangements, the electronic components 62 may be electrically connected to the circuit structure 52a by conductive wires (e.g., bonding wires).

In some arrangements, the bionic finger 2 may include conductive elements 70a, 70b, 70c, and 70d (or circuits or extendable electrical connection). In some arrangements, the conductive element 70a may be configured to electrically couple the circuit structures 52a and 52c. In some arrangements, the conductive element 70b may be configured to electrically couple the circuit structures 52b and 52d. In some arrangements, the conductive element 70c may be configured to electrically couple the circuit structures 52c and 52e. In some arrangements, the conductive element 70d may be configured to electrically couple the circuit structures 52d and 52e. In some arrangements, the conductive elements 70a, 70b, 70c, and 70d may be configured to transmit sensing signals from the sensors 60a, 60b, 60c, 60d, and/or 60e. In some arrangements, the conductive elements 70a and 70b may extend from the phalange region 20a to the phalange region 20b through the joint region 22a. In some arrangements, the conductive elements 70c and 70d may extend from the phalange region 20b to the phalange region 20c through the joint region 22b. In some arrangements, the conductive elements 70a, 70b, 70c, and 70d may be spaced apart from the encapsulant 30. The conductive elements 70a, 70b, 70c, and 70d may be exposed to the space defined by the surface 30s1 of the encapsulant 30. For example, the conductive elements 70a, 70b, 70c, and 70d may be exposed to air. In some arrangements, the conductive element 70a and conductive element 70b may partially surround the driver 42a. In some arrangements, the conductive element 70c and conductive element 70d may partially surround the driver 42b. In some arrangements, the conductive elements 70a, 70b, 70c, and 70d may undergo deformation or extension in response to the changes in the relative positions (or relative motions) of the phalange region 20a, 20b, and/or 20c. For example, the conductive elements 70a, 70b, 70c, and 70d may be configured to be deformable or deformed in response to the changes in the relative positions (or relative motions) of the phalange region 20a, 20b, and/or 20c.

In some arrangements, each of the conductive elements 70a, 70b, 70c, and 70d may include an extendable material (or extendable layer) and conductive particles within the extendable material. In some arrangements, the ductility of the extendable material ranges between 50 and 1000, such as 50, 100, 500, or 1000. In some arrangements, the extendable material may include a thermal thermoplastic material, a thermal set material, or other suitable materials. In some arrangements, the extendable material may include a non-metallic material. In some arrangements, the extendable material may include a liquid silicone rubber (LSR) or other suitable materials. In some arrangements, the conductive particles may include carbon nanotubes, metallic particles, such as silver, gold, copper, nickel, alloy, or other suitable particles.

In some arrangements, the bionic finger 2 may include conductive elements 72 (or traces or metallic wire). In some arrangements, the conductive elements 72 may be electrically coupled to the driver 42a. In some arrangements, the conductive elements 72 may be electrically coupled to the driver 42b. In some arrangements, the conductive elements 72 may be electrically coupled to the circuit structure 52a (or circuit structures 52b to 52e). In some arrangements, the conductive elements 72 may partially surround the frame 40a (or frame 40b or 40c). In some arrangements, the conductive elements 72 may be configured to transmit control signals to the driver 42a (or driver 42b). In some arrangements, the conductive element 72 may undergo a smaller extension or deformation compared to the conductive element 70 when the relative positions (or relative motions) of the phalange regions 20a, 20b, and 20c change. In some arrangements, the material of the conductive element 70 may be different from that of the conductive element 72. In some arrangements, the ductility of the conductive element 70 may be greater than that of the conductive element 72. In some arrangements, the conductive elements 72 may include a metallic material, such as copper, aluminum, silver, gold, alloy, or other suitable materials.

In this arrangement, each of the phalange regions 20a, 20b, and 20c may include sensors (e.g., the sensors 60a to 60e) configured to detect the stress generated by an object. A processor is tasked with receiving the processed sensing signals and determining whether the stress in each region (i.e., the areas corresponding to the locations of the sensors) exceeds a predetermined threshold value. If the stress surpasses this threshold, the processor will send a signal to the controllers. In response, the controllers will issue control signals to the drivers, facilitating the control, adjustment, and/or modification of the relative positions (or relative motions) among phalange regions 20a, 20b, and 20c. Consequently, this mechanism may help to reduce or prevent damage to the encapsulant 30 caused by the object. In this arrangement, the conductive elements 70a, 70b, 70c, and 70d are used to transmit sensing signals between the sensors on different circuit structures. The conductive elements 70a, 70b, 70c, and 70d may have a relatively great ductility compared to metallic materials. As a result, these conductive elements can undergo considerable elongation without fracturing, thereby facilitating the movement and/or rotation of the phalange regions 20a, 20b, and 20c. Although not shown in FIG. 1B, it should be noted that the bionic mechanical sensor 1 may include a bionic thumb, which may have two phalange regions connected by a joint region. Further, the phalange regions and joint region of the bionic thumb may have structures the same as or similar to those of the phalange region 20a (or 20b or 20c) and joint region 22a, respectively.

In this arrangement, the bionic finger 1a includes a sensing region (e.g., the region on which the sensors 60a to 60e are located) configured to generate a signal in response to an object in contact with or approaching the encapsulant 30. The bionic finger 1a includes a mechanical module (e.g., drivers 42a, 42b and frame 40) configured to deform the encapsulant 30 in response to the signal. The sensing region is closer to the outer surface (e.g., surface 30s1) of the encapsulant 30 than the mechanical module is.

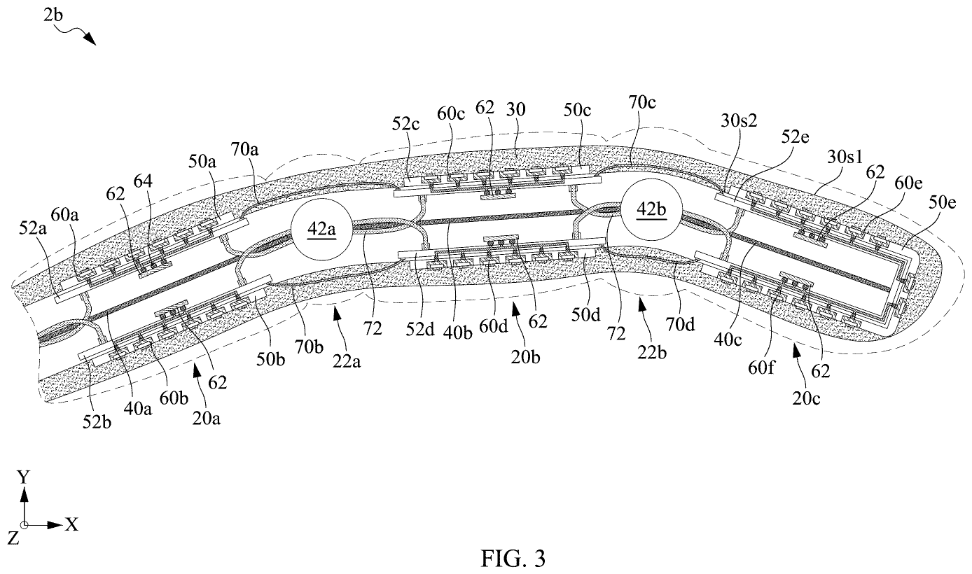

FIG. 3 illustrates a cross-sectional view of a bionic finger 2b, in accordance with some arrangements of the present disclosure. The bionic finger 2b is similar to the bionic finger 2a, differing as follows.

In some arrangements, the conductive elements 70a to 70d may be embedded within the encapsulant 30. In some arrangements, the sensors 60a to 60e may be embedded within the encapsulant 30. The conductive elements 70a to 70d may be spaced apart from the driver 42a (or driver 42b) by the encapsulant 30.

In some arrangements, the carriers 50a to 50d may be at least partially embedded within the encapsulant 30. Although FIG. 3 illustrates that the circuit structures 52a to 52e are spaced apart from the encapsulant, the circuit structures 52a to 52e may be at least partially embedded within the encapsulant 30 in other arrangements.

In this arrangement, some of the components are disposed within the encapsulant 30. In this case, the transmission path of sensing signals can be reduced, which in turn reduces the errors in the signals received by the controllers.

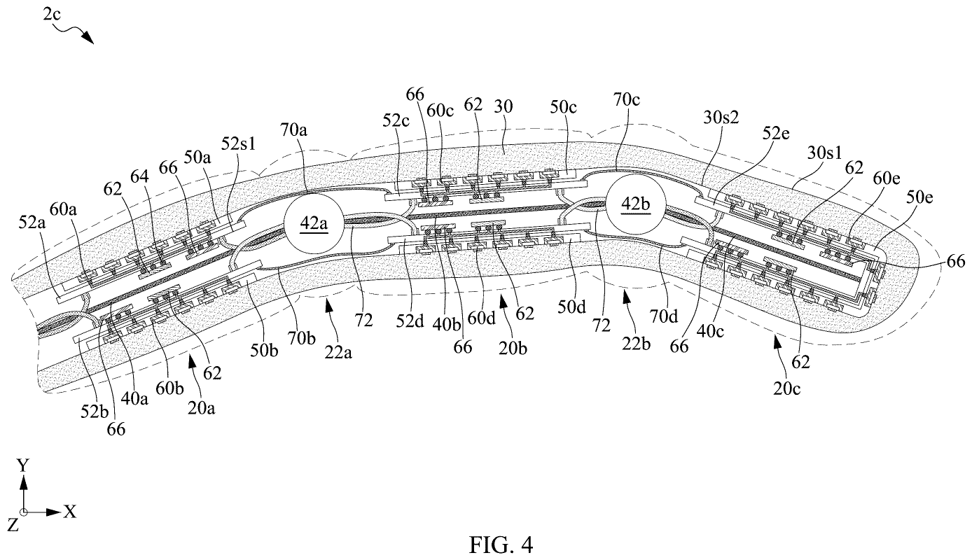

FIG. 4 illustrates a cross-sectional view of a bionic finger 2c, in accordance with some arrangements of the present disclosure. The bionic finger 2c is similar to the bionic finger 2a, differing as follows.

In some arrangements, the bionic finger 2c may include electronic components 66. In some arrangements, the electronic components 66 may be disposed on the surface 52s1 of the circuit structure 52a (or circuit structures 52b to 52e). The electronic components 66 may include an application-specific IC (ASIC), a central processing unit (CPU), a graphics processing unit (GPU), a microprocessor unit (MPU), a microcontroller unit (MCU), or other suitable integrated circuits. The electronic components 66 may function as processors. The electronic components 66 may be configured to receive the processed sensing signals from the electronic components 62 and to determine whether the electronic components 62 should transmit control signals to the driver 42a and/or 42b.

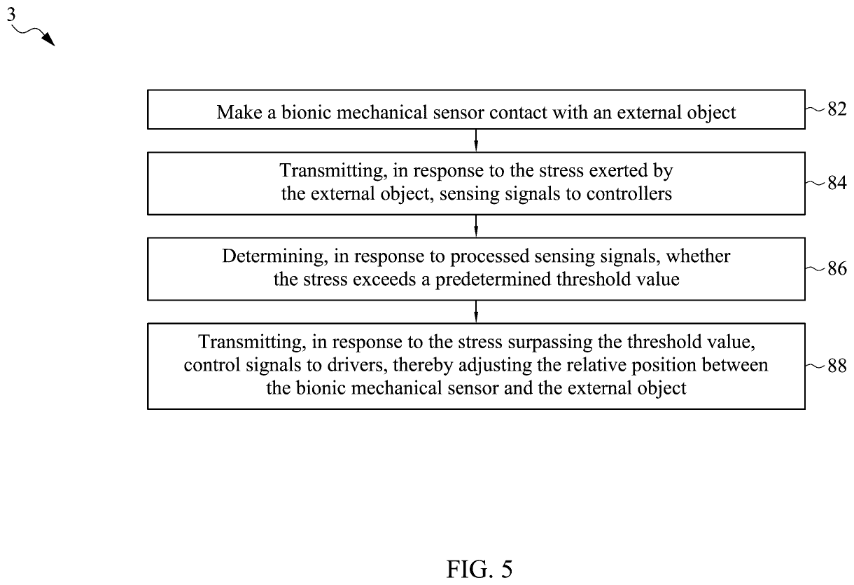

FIG. 5 is a flowchart illustrating the method 3 of an operation of a bionic mechanical sensor, in accordance with some arrangements of the present disclosure.

The method 3 may begin with an operation 82 in which a bionic mechanical sensor makes contact with and/or grasps an external object.

The method 3 may continue with an operation 84 in which sensors within the bionic mechanical sensor transmit sensing signals from different regions of the bionic mechanical sensor to the controllers in response to the stress exerted by the external object.

The method 3 may continue with an operation 86 in which processors determine, in response to processed sensing signals, whether the stress exceeds a predetermined threshold value.

The method 3 may continue with an operation 88 in which the controllers transmit control signals to drivers in response to the stress surpassing the threshold value, thereby adjusting the relative position between the bionic mechanical sensor and the external object.

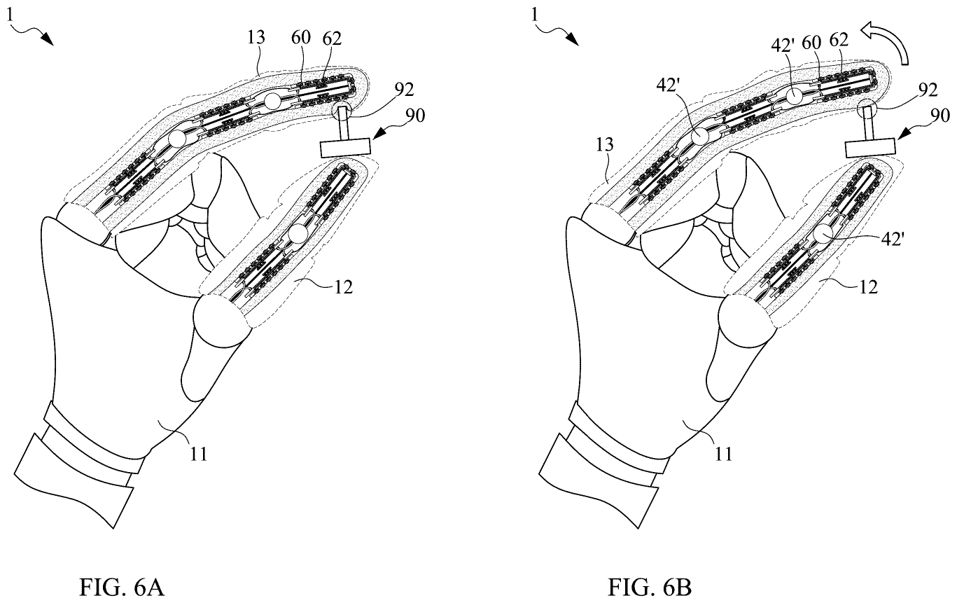

FIG. 6A and FIG. 6B illustrate stages of an example of a method of an operation of a bionic mechanical sensor according to some embodiments of the present disclosure.

Referring to FIG. 6A, the bionic mechanical sensor 1 is operated to make contact with and/or grasp an object 90 by, for example, the mechanical units 12 and 13. The sensors 60 may generate sensing signals in response to the stress exerted by the object 90 in each region of the mechanical units 12 and 13. The electronic components 62 may transmit processed sensing signals to processors (not shown in FIG. 6A). In some cases, the object 90 may apply a relatively great stress on a region 92. As a result, the stress imposed on the region 92 surpasses a predetermined threshold value.

Referring to FIG. 6B, in response to the stress surpassing the threshold value imposed on the region 92, the electronic components 62 transmit control signals to drivers 42′ of the mechanical unit 12 or 13, thereby adjusting the relative position between the region 92 and the object 90. As a result, the mechanical unit 13 (such as the region 92) may experience reduced stress, thereby preventing potential damage.

As used herein, the singular terms “a,” “an,” and “the” may include a plurality of referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 104 S/m, such as at least 10⁵ S/m or at least 10⁶ S/m. The electrical conductivity of a material can sometimes vary with temperature. Unless otherwise specified, the electrical conductivity of a material is measured at room temperature.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” the same or equal if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” parallel can refer to a range of angular variation relative to 0° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°. For example, “substantially” perpendicular can refer to a range of angular variation relative to 90° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific arrangements thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other arrangements of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. A bionic mechanical sensor, comprising:
a first rotatable region and a second rotatable region;
an encapsulant covering the first rotatable region and the second rotatable region and exposed to an external environment;
a plurality of sensors within the first rotatable region and the second rotatable region; and
a conductive element electrically connected to the plurality of sensors and embedded within the encapsulant.

2. The bionic mechanical sensor of claim 1, wherein the conductive element comprises an extendable material.

3. The bionic mechanical sensor of claim 2, wherein the conductive element comprises electrically conductive particles within the extendable material.

4. The bionic mechanical sensor of claim 3, wherein the extendable material comprises a liquid silicone rubber.

5. The bionic mechanical sensor of claim 1, further comprising:
a joint region mechanically coupled between the first rotatable region and the second rotatable region,
wherein the conductive element extends from the first rotatable region to the second rotatable region.

6. The bionic mechanical sensor of claim 5, further comprising:
a first circuit structure within the first rotatable region and a second circuit structure within the second rotatable region,
wherein the conductive element connects the first circuit structure and the second circuit structure.

7. The bionic mechanical sensor of claim 6, wherein a portion of the plurality of sensors are disposed between the first circuit structure and the encapsulant.

8. The bionic mechanical sensor of claim 6, further comprising:
a controller electrically coupled to the joint region,
wherein the plurality of sensors and the controller are disposed on opposite sides of the first circuit structure.

9. A bionic mechanical sensor, comprising:
a first rotatable region and a second rotatable region;
an encapsulant covering the first rotatable region and the second rotatable region and configured to contact an object;
a conductive element embedded within the encapsulant and connecting the first rotatable region and the second rotatable region; and
a driver disposed between the first rotatable region and the second rotatable region and configured to control a relative motion between the first rotatable region and the second rotatable region.

10. The bionic mechanical sensor of claim 9, further comprising:
a plurality of sensors within the first rotatable region and the second rotatable region.

11. The bionic mechanical sensor of claim 10, wherein the conductive element is electrically coupled to the plurality of sensors.

12. The bionic mechanical sensor of claim 9, wherein the conductive element is configured to be deformed in response to the relative motion between the first rotatable region and the second rotatable region.

13. The bionic mechanical sensor of claim 12, wherein the conductive element is between the first rotatable region and the second rotatable region.

14. The bionic mechanical sensor of claim 12, wherein the conductive element is spaced apart from the driver by the encapsulant.

15. The bionic mechanical sensor of claim 9, wherein in a cross-sectional view, the driver is spaced apart from the encapsulant.

16. A bionic mechanical sensor, comprising:
an encapsulant having an outer surface configured to be in contact with or approaching an object;
a sensing region configured to generate a signal in response to the object in contact with or approaching the encapsulant; and
a mechanical module configured to deform the encapsulant in response to the signal,
wherein the sensing region is closer to the outer surface of the encapsulant than the mechanical module is.

17. The bionic mechanical sensor of claim 16, further comprising:
a conductive element configured to transmit the signal from the sensing region,
wherein the conductive element is embedded within the encapsulant.

18. The bionic mechanical sensor of claim 17, wherein the encapsulant comprises a first region and a second region connected to the first region by a joint region, the first region and the second region are configured to have a relative motion in response to deforming the encapsulant,
and the conductive element is within the joint region.

19. The bionic mechanical sensor of claim 17, wherein the conductive element comprises a non-metallic material.

20. The bionic mechanical sensor of claim 17, wherein the sensing region comprises sensors embedded within the encapsulant.
